(19) United States
(12) Patent Application Publication
(10) Pub. No.: US 2017/0060822 A1
(43) Pub. Date: Mar. 2, 2017

(54) METHOD AND DEVICE FOR STORING STRING

(71) Applicant: Xiaomi Inc., Beijing (CN)

(72) Inventors: Zhijun CHEN, Beijing (CN); Pingze Wang, Beijing (CN); Tao Zhang, Beijing (CN)

(73) Assignee: Xiaomi Inc., Beijing (CN)

(21) Appl. No.: 15/095,387

(22) Filed: Apr. 11, 2016

(30) Foreign Application Priority Data
Aug. 31, 2015 (CN) 201510546607.4

(51) Int. Cl. G06F 17/22; G06F 17/28; G06F 17/27; G06F 3/0481

(52) U.S. Cl. CPC G06F 17/2205; G06F 3/0481; G06F 17/28; G06F 17/2705

(57) ABSTRACT

The disclosure relates to a method and device for storing string, which belongs to the field of network technology. Aspects of the disclosure provide a method for storing string. The method include receiving a string in a context for translation, acquiring a translation result of the string in the context, acquiring context information for the string and storing the context information in association with the translation result and the string within a string database.

### CROSS-REFERENCE TO RELATED APPLICATIONS

This application is based upon and claims priority to Chinese Patent Application No. 201510546607.4 filed on Aug. 31, 2015, the entire contents of which are incorporated herein by reference.

### TECHNICAL FIELD

The present disclosure relates to the field of network technology, and more particularly, to a method and device for storing string.

### BACKGROUND

With development of network related technologies, a user is able to obtain more and more variety of information via a network, wherein text information includes Chinese language information and other foreign language information. In order to attain interchange of cultures and technologies among different countries, one way is to read foreign language information to get knowledge of development of technologies as well as customs and cultures, etc. of other countries. However, if a user does not have all the knowledge about foreign languages, a translation application is desired to provide translation service to help the user to understand foreign language information.

Currently, a translation application performs translation for a string after it acquires the string desired by a user to be translated and displays a translation result on a screen. Further, in order for convenience to review by a user, the translation application stores the string and the translation result and displays them when an instruction of viewing from a user is detected.

With the foregoing method, it is possible for a user to obtain a translation result of a string, and to quickly act the stored history information when the user wants to review. However, with only the string and its translation result being displayed, it is difficult to remind the user of context information of the string, and thus a better learning effect cannot be attained.

### SUMMARY

In order to solve problems in related arts, there is provided a method and device for storing string in the present disclosure.

Aspects of the disclosure provide a method for storing string. The method include receiving a string in a context for translation, acquiring a translation result of the string in the context, acquiring context information for the string and storing the context information in association with the translation result and the string within a string database.

To receive the string in the context for translation, in an example, the method includes receiving the string in response to a detection of a truncation operation by a mouse on the string in a display screen. In another example, the method includes receiving the string in response to a detection that a time duration of a mouse operation to cause a cursor staying on the string in a display screen is longer than a pre-determined time threshold.

In an embodiment, the method includes receiving an instruction to display the string from information in the string database, and displaying the string, the translation result and the context information that is stored in association with the translation result and the string within the string database.

In another embodiment, the method includes acquiring a time for storing the context information in association with the translation result and the string in the record within the string database, and storing the time in association with the context information and the string and translation result.

Further, in an embodiment, the method includes acquiring a screen shot on a display screen with the string in the context, and identifying the context information of the string according to the screen shot. To acquire the context information for the string, in an example, the method includes acquiring a sentence in which the string is used in the context. In another example, the method includes acquiring a paragraph in which the string is used in the context.

Aspects of the disclosure provide a device for storing string. The device includes a processor and a memory for storing instructions executable by the processor. The processor is configured to receive a string in a context for translation, acquire a translation result of the string in the context, acquire context information for the string, and store the context information in association with the translation result and the string within a string database.

In an embodiment, the processor is further configured to perform at least one of: receiving the string in response to a detection of a truncation operation by a mouse on the string in a display screen, and receiving the string in response to a detection that a time duration of a mouse operation to cause a cursor staying on the string in a display screen is longer than a pre-determined time threshold.

In another embodiment, the processor is configured to receive an instruction to display the string from information in the string database, and display the string, the translation result and the context information that is stored in association with the translation result and the string within the string database.

According to an aspect of the disclosure, the processor is further configured to acquire a time for storing the context information in association with the translation result and the string in the record within the string database, and store the time in association with the context information and the string and translation result.

Further, in an example, the processor is further configured to acquire a screen shot on a display screen with the string in the context, and identify the context information of the string according to the screen shot. In an embodiment, the processor is further configured to perform acquiring a sentence in which the string is used in the context. In another embodiment, the processor is configured to perform acquiring a paragraph in which the string is used in the context.

Aspects of the disclosure provide a non-transitory computer-readable storage medium storing instructions to be executed by a processor to perform operations for storing string. The operations include receiving a string in a context for translation, acquiring a translation result of the string in the context, acquiring context information for the string, and storing the context information in association with the translation result and the string within a string database.

It is to be understood that both the forgoing general descriptions and the following detailed descriptions are exemplary and explanatory only, and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for string storing according to an exemplary embodiment of the present disclosure;

FIG. 2A is a flow chart showing a method for string storing according to an exemplary embodiment of the present disclosure;

FIG. 2B is a schematic diagram illustrating display of a string according to an exemplary embodiment of the present disclosure;

FIG. 2C is a schematic diagram illustrating display of a string according to an exemplary embodiment of the present disclosure;

FIG. 3 is a block diagram illustrating a device for string storing according to an exemplary embodiment of the present disclosure;

FIG. 4 is a block diagram illustrating a device 400 for string storing according to an exemplary embodiment of the present disclosure;

FIG. 5 is a block diagram illustrating a device 500 for string storing according to an exemplary embodiment of the present disclosure.

### DETAILED DESCRIPTION

In order for clearly clarifying the purposes, the technical solutions and advantages of the disclosure, some implementations of the present disclosure will be further described in details by reference to the accompanying drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

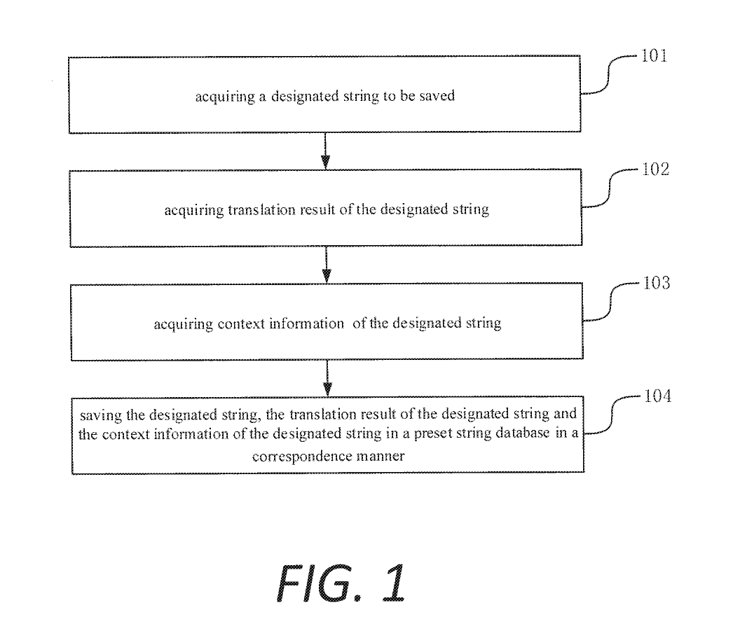

FIG. 1 is a flow chart of a method for storing string according to an exemplary embodiment of the present disclosure. As shown in FIG. 1, the method for storing string may be used in any suitable terminal device, such as a smart phone, a tablet computer, a laptop computer, a desktop computer, a messaging device, a gaming console, a medical device, exercise equipment, a personal digital assistance (PDA) and the like. The method can include following steps.

In step 101, acquiring a designated string to be stored.

In step 102, acquiring a translation result of the designated string.

In step 103, acquiring context information of the designated string.

In step 104, storing the designated string, the translation result of the designated string and the context information of the designated string in a preset string database in a corresponding manner. In an example, the context information is stored in a record in the preset string database in association with the translation result and the string. In another example, the context information is stored and is linked to the translation result which is stored in association with the string. In another example, the context information, the translation result and the string are stored according to an object-oriented model.

In an embodiment, the disclosure enables storing of context information in association with a designated string such that the designated string and the context information can be read and displayed when an instruction to look for the string stored in the preset string database from a user is detected, and thus prompt effect can be improved and thereby the user is able to quickly remind the string and its use scenes.

In a first potential implementation of the present disclosure, to acquire a designated string to be stored, the method includes

determining a string as the designated string to be stored when a truncation operation of a mouse on the string is detected; or

determining a string as the designated string to be stored when a time period of cursor of a mouse staying over the string is detected to be longer than a preset time period.

In a second potential implementation of the present disclosure, after said storing the designated string, the translation result of the designated string and the context information of the designated string in a preset string database in a corresponding manner, the method further comprises:

displaying the designated string, the translation result of the designated string and the context information of the designated string when an instruction of viewing the designated string in the preset string database is detected.

In a third potential implementation of the present disclosure, the method further includes:

acquiring storing time information of the designated string, the translation result of the designated string and the context information of the designated string; and

storing the storing time information in the preset string database together with storing of the designated string, the translation result of the designated string and the context information of the designated string in a corresponding manner.

In a fourth potential implementation of the present disclosure, said acquiring context information of the designated string comprises:

acquiring screen shot of current location of the designated string; and

identifying the context information of the designated string according to result of the screen shot.

All of the forgoing technical solutions can be combined in a suitable manner to form an alternative embodiment of the disclosure, which will not be elaborated herein.

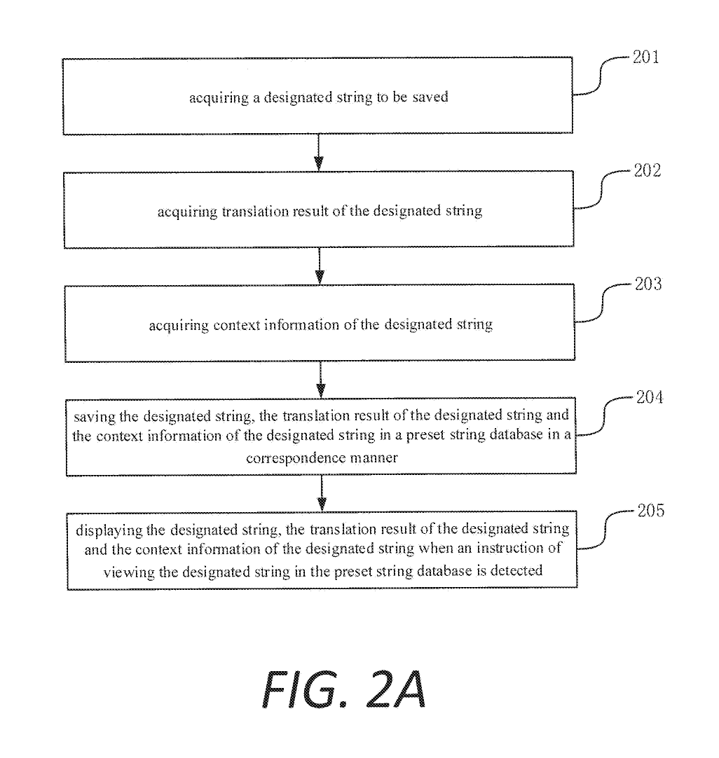

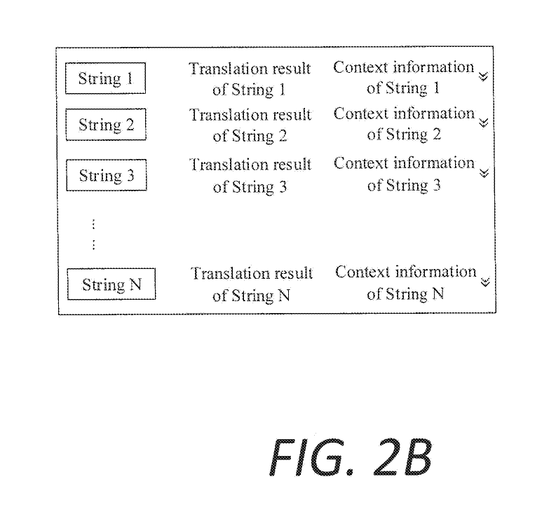

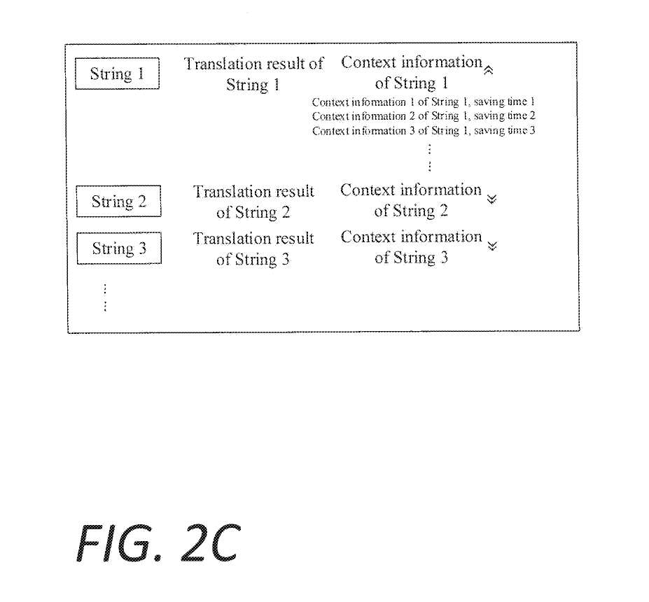

FIG. 2A is a flow chart illustrating a method for storing string according to an exemplary embodiment of the present disclosure. The method can be executed by a terminal device, such as a smart phone, a tablet computer, a laptop computer, a desktop computer, a messaging device, a gaming console, a medical device, exercise equipment, a personal digital assistance (PDA) and the like. Referring to FIG. 2A, the embodiment particularly comprises the following steps.

In step 201, acquiring a designated string to be stored.

The designated string may be a word desired to be translated, or desired to be stored after translation for further review. The following two methods can be used for determining a designated string.

The first method is to determine a string as the designated string to be stored when a truncation operation of a mouse on the string is detected. The truncation operation refers to drawing through, for example entire content of the string, by a cursor in response to a mouse operation. In an example, the mouse operation includes three steps: pressing a left key of the mouse when the cursor stays at a start or an end of the string; moving the mouse to cause dragging the cursor to the end or the start of the string; and releasing the left key of the mouse. By doing so, a truncation operation for the string is completed.

The second method is to determine a string as the designated string to be stored when a time period of cursor of a mouse staying over the string is detected to be longer than a preset time period. The location of the cursor staying over the string may be at a position displaying the string on a screen, or may be within a designated range comprising the position displaying the string on the screen. The preset time period may be in the order of a second.

The forgoing methods for determining a string as the designated string to be stored are provided for word selection with a mouse. For a terminal with a touch screen, determination of a string as the designated string may be done based on particular location and stay time of a touch operation, or the like. The touch operation based method is similar to the above discussed determination method using a mouse, and thus will be not elaborated herein.

It step 202, acquiring a translation result of the designated string.

Taking the designated string acquired in step 201 as a string to be translated, a search is made using a translation engine with the string as an index to obtain a translation result of the string. The following two methods may be used for acquiring a translation result.

The first method is used when the terminal device is in a status disconnected with a network. The first method searches, in a basic lexicon that stores basic interpretations of strings, for a translation result of the string. The translation result acquired from the basic lexicon will be used as a final translation result.

The second method is used when the terminal device is in a status corrected with a network. The second method searches in a networking lexicon for a translation result of the string and searches in a basic lexicon for a translation result of the string. The networking lexicon stores interpretations of strings over the network and contents stored in the network lexicon may be updated periodically to provide translation results of strings in art updated and complete manner. The final translation result in the second method includes the translation result acquired from the basic lexicon and the translation result acquired from the networking lexicon.

Moreover, when the terminal device is in a status connected with a network, it is possible to search directly in a networking lexicon for a translation result of a string. The method for acquiring the translation result is not limited to the embodiments described in the present disclosure.

It should be noted that upon acquisition of the translation result, the translation result may be displayed near the corresponding string, or may be displayed near the cursor of the mouse. The position for displaying the translation result is not limited to the embodiments described in the present disclosure.

It step 203, acquiring context information of the designated string.

In an embodiment, the context information refers to information, such as a sentence or a paragraph to which the string currently belongs. The method for acquiring the context information may comprise the following two steps:

Step 1, screen shot of current location of the designated string is acquired. Display position information of the string on the screen may be obtained from the screen shot. The display position information may be coordinate information of pixels of a rectangle box of the screen shot.

Step 2, the context information of the designated string is identified according to result of the screen shot.

Specifically, in an example, the context information of the designated string is identified according to the display position information of the string on the screen acquired in Step 1. Particular, OCR (Optical Character Recognition) technology may be used for context information identification. When the context information is a sentence to which the designated string belongs, identification of the sentence can be performed from right and left sides of the rectangular box of the screen shot. For example, the identification can be conducted from the coordinate position of left side of the rectangular box of the screen shot toward a left direction, and when the identification proceeds to a punctuation representing end of the sentence, the identification is terminated and the identified content is included in the context information. Similarly, the identification can be conducted from the coordinate position of right side of the rectangular box of the screen shot toward a right direction, and when the identification proceeds to a punctuation representing end of the sentence, the identification is terminated and the identified content is included in the context information. The punctuation representing: end of a sentence may be a period (.), an exclamation point (!), a question mark (?) and the like when the content to be identified is in foreign language. The punctuation representing end of a sentence may be a period (,), an exclamation point (!), a question mark (?) and the like when the content to be identified is in Chinese language.

When the context information refers to a paragraph to which the designated string currently belongs, the identification may be conducted from the coordinate position of left side of the rectangular box of the screen shot toward a left direction, and when successive space symbols are detected, the identification is terminated and the identified content is included in the context information. Similarly, the identification may be conducted from the coordinate position of right side of the rectangular box of the screen shot toward a right direction, and when successive space symbols are detected, the identification is terminated and the identified content is included in the context information.

In addition to OCR technology for identifying the context information, other identification technologies may be used for identifying context information of the string The identification technology is not limited to the embodiments described in the disclosure.

In step 204, storing the designated string:, the translation result of the designated string and the context information of the designated string in a preset string: database in a corresponding manner.

The preset string database is used for storing string information, such as the translation results of strings, the context information of strings, and the like, for a user to view and review in the future. The preset string database can store string information for a string in association with the string. The preset string database can use any suitable technique to associate the string, the translation of the string and the context information of the string. The method for storing a string, a translation result of the string and the context information can include a determination whether the string exists in the preset string database. When the string does not exist in the preset string database, the method can include storing the string, the translation result of the string and the context information of the string in association in the preset string database. When the string exists in the preset string database, the method includes a determination whether the stored context information in the preset string database is the same as the context information to be stored. When the stored context information in the preset string database is the same as the context information to be stored, in an example, the preset string database is maintained without change When the context information to be stored is not the same as the stored context information of the string, the context information is new to the preset string database. Then, in an example, the method can include storing the new context information, and associating the stored new context information with the string.

Moreover, for better prompt effect, in an embodiment, the preset string database can further store the time information for each piece of context information of the string. A particular method for the storing the time information can include a determination whether the string to be stored exists in the preset string database. When the string to be stored does not exist in the preset string database, the method can include storing the string, translation result of the string, the context information of the string, as well as a time information associated with the context information of the string. The time information for the context information can be a present system time of the terminal device. When the string to be stored already exists in the preset string, the method includes a determination whether the stored context information of the string in the preset string database is the same as the context information to be stored. When the stored context information of the string in the preset string database is the same as the context information to be stored, in an example, the time information for the context information of the string can be updated. For example, the time information associated with the context information of the string in the preset database is updated with the present system time of the terminal device. When the stored context information of the string in the preset string database is not the same as the context information to be stored, the method can include storing the context information to be stored I association with a time information, and associating the context information with the string in the preset string database. It is noted that any suitable technique or suitable data structure model can be used to associate the context information with the string. In an example, a memory space in the database is allocated for a string. The context information can be stored in the memory space. In another example:, a pointer technique is used to link the context information with the string.

The preset string database may farther store other information related to the string to be stored. In addition to the above described method for storing, other methods may be used for the storing, which is not limited to the embodiment of the present disclosure.

In step 205, displaying the designated string, the translation result of the designated string and the context information of the designated string when an instruction of viewing the designated string in the preset string database is detected.

FIG. 2B is a schematic diagram illustrating display of context information of strings. The method for determining sequence for display of strings may be that: when the strings are words in foreign language, the strings may be displayed in, for example, an alphabetical order of a first letter of respective word; when the strings are in a Chinese language, the strings may be displayed in the order of a first letter of Chinese Pinyin of a first word of the string; when stored contents comprise storing time information for context information of respective string, the strings may be displayed in the order of respective storing time. In addition to the above described methods, other methods may be used for display in a certain sequence, which is not limited to the embodiment of the disclosure.

Further, in order to display, in an interface, strings stored in the preset string database as many as possible, foldable display may be employed to display context information of strings. As shown in FIG. 2B, the icon on the right side of the “context information of the String 1” is an icon for spreading display operation. When a click operation by a user on the icon is detected, the display interface is switched to the interface as shown in FIG. 2C. In FIG. 2C, the corresponding position spreads a display region in which the context information of the String 1 is displayed. In the case that stored contents comprise storing time information for context information of the string, the corresponding position may further display the time information. As shown in FIG. 2C, the icon on the right side of the “context information of the String 1” is an icon for retraction display operation. When a click operation by a user on the icon is detected, the display interface is switched to the interface as shown in FIG. 2B.

In addition to the above described method, other methods may be used to display context information of the string, which is not limited to the embodiment of the present disclosure.

The embodiment of the present disclosure enables storing of a designated string and context information thereof at the same time such that the designated string and the context information thereof can be displayed at the same time when an instruction of viewing the string stored in the preset string database from a user is detected, and thus prompt effect can be improved and thereby the user is able to quickly remind the string and its use scenes. Moreover, with the foldable display, a display interface can display strings stored in the preset string database as many as possible, which enables convenience for a user to view.

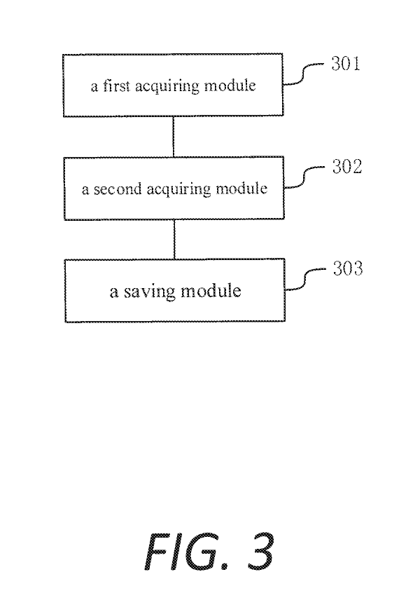

FIG. 3 is a block diagram illustrating a device for string storing according to an exemplary embodiment of the present disclosure. Referring to FIG. 3, the device comprises a first acquiring module 301, a second acquiring module 302 and a storing module 303.

The first acquiring module 301 is configured to acquire a designated string to be stored.

The second acquiring module is configured to acquire a translation result of the designated string.

The first acquiring module is further configured to acquire context information of the designated string;

The storing module is configured to storing the designated string, the translation result of the designated string and the context information of the designated string in a preset string database in a correspondence manner.

In a first potential implementation of the present disclosure, the first acquiring module is configured to determine any string as the designated string to be stored when a truncation operation of a mouse on the string is detected; or determine any string as the designated string to be stored when a time period of cursor of a mouse staying over the string is detected to be longer than a preset time period.

In a second potential implementation of the present disclosure, the device further comprises a displaying module configured to display the designated string, the translation result of the designated string and the context information of the designated string when an instruction of viewing the designated string in the preset string database is detected.

In a third potential implementation of the present disclosure, the first acquiring module is further configured to acquire storing time information of the designated string, the translation result of the designated string and the context information of the designated string; and the storing module is further configured to store the storing time information in the preset string database together with storing of the designated string, the translation result of the designated string and the context information of the designated string in a correspondence manner.

In a fourth potential implementation of the present disclosure, the second acquiring module is configured to acquire screen shot of current location of the designated string; and identify the context information of the designated string according to result of the screen shot.

With respect to the devices in the above embodiments, the specific manners for performing operations for individual modules therein have been described in detail in the embodiments regarding the methods for string storing, which will not be elaborated herein. It is noted that the various modules in the disclosure can be implemented by suitable technology. In an example, a module can be implemented as integrated circuits. In another example, a module can be implemented as a processor executing software instructions.

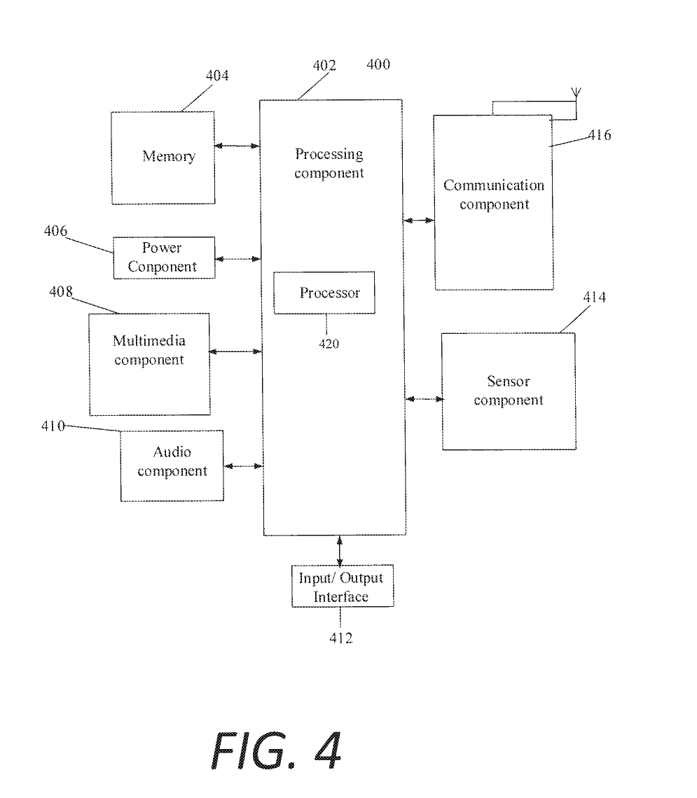

FIG. 4 is a block diagram illustrating a device 400 for string storing according to an exemplary embodiment of the present disclosure. For example, the device 400 may be a mobile phone, a computer, a digital broadcast terminal device, a messaging device, a gaming console, a tablet, a medical device, an exercise equipment, a personal digital assistance, and the like.

Referring to FIG. 4, the device 400 may include one or more of the following components: a processing component 402, a memory 404, a power component 406, a multimedia component 408, an audio component 410, an input/output (I/O) interface 412, a sensor component 414 and a communication component 416.

The processing component 402 typically controls overall operations of the device 400, such as operations associated with display, telephone calls, data communications, camera operations, and recording operations. The processing component 402 may include one or more processors 420 to execute instructions to perform all of or part of the steps in the above described methods. Moreover, the processing component 402 may include one or more modules which facilitate the interaction between the processing component 402 and other components. For instance:, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 406 provides power to various components of the device 400. The power component 406 may include a power management system, one or more power sources, and any other components associated with the generation, management and distribution of power in the device 400.

The multimedia component 408 includes a screen providing an output interface between the device 400 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, hut also sense a period of time and a pressure associated with the touch or swipe action. In some embodiments, the multimedia component 408 includes a frond camera and/or a rear camera. The front camera and/or the rear camera may receive an external multimedia datum while the device 400 is in an operation mode, such as photographing mode or a video mode. Each of the front camera and the rear camera may be a fixed optical lens system or have focus and optical zoom capability.

The audio component 410 is configured to input and/or output audio signals. For example, the audio component 410 includes a microphone (“MIC”) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and a periphery interface module, such as a keyboard, a click wheel, buttons, and the like. The buttons may include, but are not limited to, a home button, a volume button, a starting button, and a locking button.

The sensor component 414 includes one or more sensors to provide status assessment of various aspects of the device 400. For instance, the sensor component 414 may detect open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging application. In some embodiments, the sensor component 414 may also include an acceleration sensor, a gyroscope sensor, a magnetic sensor, a pressure sensor or a temperature sensor.

The communication component 416 is configured to facilitate communication, wired or wirelessly, between the device 400 and other devices. The device 400 can access a wireless network based on a communication standard, such as WiFi, 2G, or 3G-, or a combination thereof. In an exemplary embodiment, the communication component 416 receives a broadcast signal or broadcast associated information from an external broadcast management system via a broadcast channel. In an exemplary embodiment, the communication component 416 further includes a Near Field Communication (NFC) module to facilitate short-range communications. For example, the NFC module may be implemented based on a Radio Frequency Identification (RFID) technology, an Infrared Data Association (IrDA) technology, a Ultra Wideband (UWB) technology, a Blue Tooth (BT) technology, and other technologies.

In exemplary embodiments, the device 400 may be implemented with one or more Application Specific integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, micro-processors, or other electronic components, for performing the above described methods.

In exemplary embodiments, there is also provided a non-transitory computer readable storage medium including instructions, such as included in the memory 404, executable by the processor 420 of the device 400, for performing the above described methods. For example, the non-transitory computer readable storage medium may be a ROM, a RAM, a CD-ROM, a magnetic tape, a floppy disk, an optical data storage device, and the like.

In exemplary embodiments, there is also provided a non-transitory computer readable storage medium. The instructions in the storage medium, when executed by a processor of a mobile terminal, enable the mobile terminal to perform the above described method for string storing.

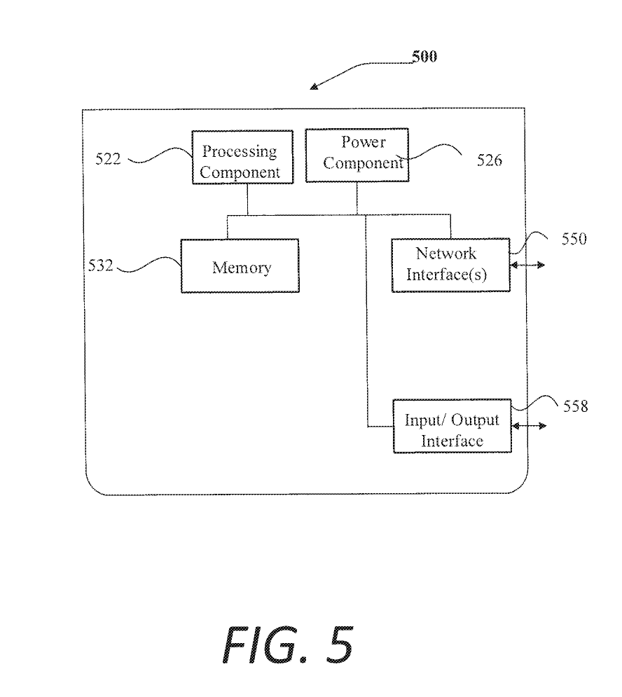

FIG. 5 is a block diagram illustrating a device 500 for storing string according to an exemplary embodiment of the disclosure. For example, the device 500 may be a server. Referring to FIG. 5, the device 500 includes a processing component 522 which in turn comprises one or more processors, and memory resources, represented by the memory 532, for storing instructions executable by the processing component 522, such as applications. The applications stored in the memory 532 may include one or more modules with each module corresponding to a set of instructions. Moreover, the processing component 522 is configured to perform instructions to implement the above described method for string storing.

The device 500 may also include a power component 526 configured to perform power management of the device 500; a wired or wireless network interface 550 configured to connect the device 500 to a network; and an input/output (I/O) interface 558. The device 500 can operate based on an operation system stored in the memory 532, such as Windows Server™, Mac OS X™, Unix™, Linux™, FreeBSD™, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and embodiments are merely considered to be exemplary and the substantive scope and spirit of the disclosure is limited only by the appended claims.

It should be understood that the disclosure is not limited to the precise structure as described above and shown in the figures, but can have various modification and alternations without departing from the scope of the disclosure. The scope of the disclosure is limited only by the appended claims.

What is claimed is:

1. A method for storing string, comprising:
receiving a string in a context for translation;
acquiring a translation result of the string in the context;
acquiring context information for the string; and
storing the context information in association with the translation result and the string within a string database.

2. The method of claim 1, wherein receiving the string in the context for translation comprises at least one of:
receiving the string in response to a detection of a truncation operation by a mouse on the string in a display screen; and
receiving the string in response to a detection that a time duration of a mouse operation to cause a cursor staying on the string in a display screen is longer than a pre-determined time threshold.

3. The method of claim 1, further comprising:
receiving an instruction to display the string from information in the string database; and
displaying the string, the translation result and the context information that is stored in association with the translation result and the string within the string database.

4. The method of claim 1, further comprising:
acquiring a time for storing the context information in association with the translation result and the string in the record within the string database; and
storing the time in association with the context information and the string and translation result.

5. The method of claim 1, wherein acquiring the context information for the string comprises:
acquiring a screen shot on a display screen with the string in the context; and
identifying the context information of the string according to the screen shot.

6. The method of claim 1, wherein acquiring the context information for the string comprises at least one of:
acquiring a sentence in which the string is used in the context; and
acquiring a paragraph in which the string is used in the context.

7. A device for storing string, comprising:
a processor; and
a memory for storing instructions executable by the processor;
wherein the processor is configured to:
receive a string in a context for translation;
acquire a translation result of the string in the context;
acquire context information for the string; and
store the context information in association with the translation result and the string within a string database.

8. The device of claim 7, wherein the processor is further configured to perform at least one of:
receiving the string in response to a detection of a truncation operation by a mouse on the string in a display screen; and
receiving the string in response to a detection that a time duration of a mouse operation to cause a cursor staying on the string in a display screen is longer than a pre-determined time threshold.

9. The device of claim 7, wherein the processor is further configured to:
receive an instruction to display the string from information in the string database; and
display the string, the translation result and the context information that is stored in association with the translation result and the string within the string database.

10. The device of claim 7, wherein the processor is further configured to:
acquire a time for storing the context information in association with the translation result and the string in the record within the string database; and
store the time in association with the context information and the string and translation result.

11. The device of claim 7, wherein the processor is farther configured to:
acquire a screen shot on a display screen with the string in the context; and
identify the context information of the string according to the screen shot.

12. The device of claim 7, wherein the processor is further configured to perform at least one of:
acquiring a sentence in which the string is used in the context; and
acquiring a paragraph in which the string is used in the context.

13. A non-transitory computer-readable storage medium storing instructions to be executed by a processor to perform operations for storing string, the operations comprising:
receiving a string in a context for translation;
acquiring a translation result of the string in the context;
acquiring context information for the string; and
storing the context information in association with the translation result and the string within a string database.

14. The non-transitory computer-readable storage medium of claim 13, wherein the operation of receiving the string in the context for translation comprises at least one of:
receiving the string in response to a detection of a truncation operation by a mouse on the string in a display screen; and
receiving the string in response to a detection that a time duration of a mouse operation to cause a cursor staying on the string in a display screen is longer than a pre-determined time threshold.

15. The non-transitory computer-readable storage medium of claim 13, the operations further comprising:
receiving an instruction to display the string from information in the string database; and
displaying the string, the translation result and the context information that is stored in association with the translation result and the string within the string database.

16. The non-transitory computer-readable storage medium of claim 13, the operations further comprising:
acquiring a time for storing the context information in association with the translation result and the string in the record within the string database; and
storing the time in association with the context information and the string and translation result.

17. The non-transitory computer-readable storage medium of claim 13, wherein the operation of acquiring the context information for the string comprises:
acquiring a screen shot on a display screen with the string in the context; and
identifying the context information of the string according to the screen shot.

18. The non-transitory computer-readable storage medium of claim 13, wherein the operation of acquiring the context information for the string comprises at least one of:
acquiring a sentence in which the string is used in the context; and
acquiring a paragraph in which the string is used in the context.
